(19) United States
(12) Patent Application Publication
(10) Pub. No.: US 2005/0264475 A1
(43) Pub. Date: Dec. 1, 2005

(54) Plasma display device and driving method thereof

(76) Inventor: Sang-Hoon Yim, Suwon-si (KR)

Correspondence Address: CHRISTIE, PARKER & HALE, LLP, PO BOX 7068, PASADENA, CA, 91109-7068, US

(21) Appl. No.: 11/106,863

(22) Filed: Apr. 15, 2005

(30) Foreign Application Priority Data
May 31, 2004 (KR) 10-2004-0038926
May 31, 2004 (KR) 10-2004-0038929

(51) Int. Cl. G09G 3/28

(52) U.S. Cl. 345/60

(57) ABSTRACT

A plasma display device and a driving method thereof. For a plasma display device having an M electrode between X and Y electrodes, a sustain pulse is applied to the X and Y electrodes during an entire period, and a reset waveform and a scan pulse are applied to the M electrode. In addition, a scan pulse is applied to the M electrode while applying the sustain pulse to the X or the Y electrode. As a result, a gently decreasing reset waveform may be used so as to enhance contrast. Furthermore, driving circuits for driving the X and Y electrodes may be designed with the same scheme. In addition, an accurate address operation may be achieved.

### CROSS-REFERENCES TO RELATED APPLICATIONS

This application claims priority to and the benefit of Korean Patent Application Nos. 10-2004-0038926 and 10-2004-0038929 filed in the Korean Intellectual Property Office on the same day of May 31, 2004, the entire contents of which are incorporated herein by reference.

### BACKGROUND OF THE INVENTION

1. (a) Field of the Invention

The present invention relates to a plasma display device and a driving method thereof. More particularly, the present invention relates to a plasma display device and a driving method thereof wherein the plasma display device is driven by an address-while-display (AWD) method.

2. (b) Description of the Related Art

A plasma display device is a flat panel display that uses plasma generated by gas discharge to display characters or images. It includes a plasma display panel (PDP) and peripheral circuits. The PDP includes, depending on its size, more than several scores to millions of pixels arranged in a matrix pattern.

Such a PDP is classified as a direct current (DC) type or an alternating current (AC) type according to its discharge cell structure and the waveform of the driving voltage applied thereto.

The DC PDP has electrodes exposed to a discharge space, and accordingly, it allows a DC to flow through the discharge space while a voltage is applied. Therefore, such a DC PDP problematically requires a resistance for limiting the current. On the other hand, the AC PDP has electrodes covered with a dielectric layer that forms a capacitor to limit the current and protects the electrodes from the impact of ions during discharge. Accordingly, the AC PDP has a longer lifetime than the DC PDP.

FIG. 1 is a partial perspective view of a conventional AC PDP. The PDP includes a pair of glass substrates 1, 6 disposed apart but facing each other. A plurality of scan electrodes 4 and sustain electrodes 5 are formed in parallel and by pairs on the glass substrate 1, and the scan electrodes 4 and the sustain electrodes 5 are covered with a dielectric layer 2 and a protective layer 3. A plurality of address electrodes 8 are formed on the glass substrate 6, and they are covered with an insulation layer 7. On the insulation layer 7, barrier ribs 9 are formed between two adjacent address electrodes 6. In addition, phosphor 10 is formed on a surface of the insulation layer 7 and on both sides of the barrier ribs 9. The glass substrates 1, 6 are arranged facing each other interposing a discharge space 11 such that the scan electrodes 4 and the sustain electrodes 5 lie substantially perpendicular to the address electrodes 8. A discharge cell (hereinafter simply called a cell) 12 is formed by a discharge space 11 formed at an intersection region of the address electrode 8 and a pair of a scan electrode 4 and a sustain electrode 5.

As shown in FIG. 2, the electrodes of the PDP of FIG. 1 are arranged in an n x m matrix structure. The PDP includes a plurality of address electrodes A₁ to Aₘ arranged in a column direction, a plurality of sustain electrodes X₁ to Xₙ arranged in a row direction, and a plurality of scan electrodes Y₁ to Yₙ arranged in a row direction.

One frame of the plasma display device is divided into a plurality of subfields, and each subfield includes a reset period, an address period, and a sustain period.

The reset period is for initializing the state of each discharge cell so as to facilitate an addressing operation on the discharge cell. The address period (also called a scan period or a writing period) is for selecting turn-on/turn-off cells (i.e., cells to be turned on or off) in a panel and accumulating wall charges to the turn-on cells (i.e., addressed cells). The sustain period is for causing a discharge for displaying an image on the addressed cells.

The PDP shown in FIG. 1 and FIG. 2 is typically driven by an address-display-separation (ADS) driving scheme. FIG. 3 illustrates a conventional ADS driving method. Each frame is divided into eight subfields SF1-SF8 in order to realize a time-division grayscale display. In addition, the subfields SF1-SF8 are respectively divided into reset periods (not shown), address periods A1-A8, and sustain periods S1-S8.

In each reset period (not shown), an erase waveform is applied to every Y electrode so as to eliminate wall charges formed in the sustain period, and then a reset waveform is applied to initialize the state of each cell so as to facilitate an address operation.

In the address periods A1-A8, address signals are applied to the address electrodes A₁-Aₘ and at the same time, a scan pulse is sequentially applied to the scan electrodes Y₁-Yₙ (as seen in FIG. 2).

During such a process, for discharge cells applied with an address signal of a high level while the scan pulse is applied, wall charges are formed therein by an address discharge. For discharge cells other than such discharge cells, wall charges are not formed.

During the sustain periods S1-S8, a sustain pulse is alternately applied to whole scan electrodes Y₁-Yₙ and whole sustain electrodes X₁-Xₙ, and accordingly, a display discharge occurs in the discharge cells formed with wall charges during the address periods A1-A6.

The brightness of a PDP is proportional to a duration of a sustain period S1-S8 occupied in each frame. A total duration of the sustain periods S1-S8 in each frame is 255T wherein T denotes a unit duration. Therefore, 256 grayscales may be realized in total including the case in which no display occurs in the frame.

According to such an ADS driving method, time zones of the subfields SF1-SF8 are separated in the frame, and accordingly, time zones of reset, address, and sustain periods in the subfields SF1-SF8 are also separated. Therefore, even if a specific pair of a first scan electrode and a first sustain electrode are addressed in the address period, a sustain discharge operation may not be immediately achieved, and the sustain discharge operation has to be delayed until every other pair of a scan and a sustain electrode are completely addressed. Consequently, the address period is lengthened in each subfield such that a display period (i.e., a sustain discharge period) is relatively reduced, resulting in deterioration of brightness of light emitted from the PDP.

To solve such a problem, an address-while-display (AWD) driving scheme has been proposed. FIG. 4 illustrates a conventional AWD driving method. Each frame is divided into eight subfields SF1-SF8 in order to realize time-division grayscale display. Each subfield in the frame overlaps every other subfield with respect to the scan electrodes Y₁-Yₙ. Therefore, every subfield SF1-SF8 exists at any time point. For example, at a given time point, while an i-th scan electrode is applied with a scan pulse for addressing, a j-th scan electrode is applied with a sustain pulse. That is, addressing and display operations are simultaneously achieved. In this case, a brightness of a PDP is proportional to a duration of a sustain period S1-S8 occupied in a frame, and accordingly, 256 grayscales may be effectively realized.

FIG. 5 illustrates an AWD driving waveform disclosed in U.S. Pat. No. 6,495,968. EP denotes an erase pulse for eliminating wall charges accumulated in a previous sustain discharge, and RPy denotes a reset pulse for initializing a state of a discharge cell before an address operation. In addition, DPi and SP respectively denote an address pulse and a scan pulse, and due to the address pulse DPi and the scan pulse SP, the address electrode and the Y electrode respectively gather negative and positive wall charges. IPy and lPx respectively denote sustain pulses applied to the Y and X electrodes. As shown in FIG. 5, while a specific Y electrode is being addressed by being applied with a scan pulse, a sustain pulse is applied to the other Y or X electrode.

However, according to the conventional AWD driving method shown in FIG. 5, a scan operation is performed only for scan electrodes (i.e., Y electrodes) but not for sustain electrodes (X electrodes). Therefore, according to such a conventional AWD driving method wherein the scan operation is performed only for the scan electrodes, accurate address operation becomes difficult since a width of the scan pulse is consequently narrowed. In addition, the scan operation is not sufficiently performed, thereby limiting the number of possible subfields.

Furthermore, as shown in FIG. 5, a reset pulse employed in the conventional AWD driving method is much shorter than a reset waveform used in an ADS driving method. Therefore, a dark room contrast ratio (hereinafter called DRDC) is deteriorated. In addition according to the conventional AWD driving method shown in FIG. 5, different waveforms are applied to the Y and X electrodes since the X electrode is applied with only the sustain pulse IPx but the Y electrode is applied with the erase pulse EP, the reset pulse RPy, and the scan pulse SP as well as the sustain pulse. Therefore, a driving circuit for driving the Y electrode is different from that for driving the X electrode, and impedances of driving circuits for X and Y electrodes may not match each other. In this case, discharge may become faulty since a waveform alternately applied to the X and Y electrodes may be distorted in the sustain discharge period.

In addition, according to a conventional AWD driving method, a waveform applied to the Y electrode is complex, and accordingly, an energy recovery circuit (ERC) used for the Y electrode also becomes complex.

### SUMMARY OF THE INVENTION

In accordance with the present invention an AWD driving method having the advantages of enhancing contrast and performing an accurate address operation, and a plasma display device and a driving method thereof having an advantage of preventing faulty discharge, have been provided.

An exemplary driving method of a plasma display device according to an exemplary embodiment of the present invention is for driving a plasma display device having at least one first electrode and at least one second electrode each applied with a sustain pulse, at least one third electrode formed in a same direction with the first and second electrodes, and at least one fourth electrode crossing the first, second, and third electrodes. According to such a driving method, the sustain pulse is alternately applied to the first and second electrodes during a first period, and a reset waveform is applied to the third electrode during a partial period of the first period.

In a further embodiment, the reset waveform gradually decreases from a first voltage to a second voltage.

In another further embodiment, a scan pulse and an address voltage are respectively applied to the third electrode and the fourth electrode after the applying of the reset waveform.

In another further embodiment, after the applying of the reset waveform, a first scan pulse is applied to the third electrode corresponding to the first electrode, a second scan pulse is applied to the third electrode corresponding to the second electrode; and an address voltage is applied to the third electrode.

In another further embodiment, the reset waveform is applied to the third electrode while a plurality of sustain pulses are applied to the first or second electrode.

In another further embodiment, the at least one first, second, third, and fourth electrodes are respectively provided as a plurality. A discharge cell is formed by corresponding first, second, third, and fourth electrodes. A sustain discharge is performed by applying the sustain pulse to the first or the second electrode forming an m-th discharge cell while an address operation is performed by applying a scan pulse to the third electrode forming a j-th discharge cell. In this case, the reset waveform may be simultaneously applied to a predetermined number of the third electrodes.

The third electrode may be biased at a third voltage after the applying of the scan pulse to the third electrode and the address voltage to the fourth electrode. In this case, the first and third voltages may be of a same voltage level.

In another further embodiment, a same waveform is applied to the first and second electrode throughout an entire period.

In another further embodiment, the third electrode is formed between the first and second electrodes.

Another exemplary driving method of a plasma display device according to an exemplary embodiment of the present invention is for driving a plasma display device having first and second electrodes applied with a sustain pulse, a third electrode formed in a same direction with the first and second electrodes, and a fourth electrode crossing the first, second, and third electrodes. According to such a driving method, the sustain pulse is alternately applied to the first and second electrodes during a first period, and a scan pulse is applied to the third electrode and an address voltage to the fourth electrode during a partial period of the first period.

In a further embodiment, the at least one first, second, third, and fourth electrodes are respectively provided as a plurality. A discharge cell is formed by corresponding first, second, third, and fourth electrodes. A sustain discharge is performed by applying the sustain pulse to the first or the second electrode forming an m-th discharge cell while an address operation is performed by applying a scan pulse to the third electrode forming a j-th discharge cell.

In another further embodiment, the same waveform is applied to the first and second electrodes throughout an entire period.

In another further embodiment, the third electrode is formed between the first and second electrodes.

An exemplary plasma display device according to an exemplary embodiment of the present invention includes a plasma display panel, an address driver, an X electrode driver, a Y electrode driver, an M electrode driver, and a controller.

The plasma display panel includes X and Y electrodes applied with a sustain discharge voltage pulse, an M electrode formed in a same direction with the X and Y electrodes, and an address electrode insulated from and crossing the X, Y, and M electrodes. The address driver applies a display data signal for selecting a discharge cell to the address electrode. The X electrode driver and the Y electrode driver respectively applies, during a first period, a sustain discharge voltage pulse for performing a sustain discharge to the X and Y electrodes. The M electrode driver applies a scan pulse to the M electrode while the sustain pulse is applied to the X and Y electrodes. The controller supplies a control signal to the address driver, the X electrode driver, the Y electrode driver, and the M electrode driver.

In another further embodiment, before applying the scan pulse, the M electrode driver applies a reset waveform decreasing from a first voltage to a second voltage to the M electrode during a partial period of the first period.

In another further embodiment, the M electrode driver applies a reset waveform to the M electrode while a plurality of sustain pulses are applied to the X or Y electrode.

In another further embodiment, the M electrode is formed between the first and second electrodes.

### BRIEF DESCRIPTION OF THE DRAWINGS

FIG. 1 is a partial perspective view of a conventional AC PDP.

FIG. 2 shows an arrangement of electrodes in the AC PDP of FIG. 1.

FIG. 3 illustrates a conventional ADS driving method.

FIG. 4 illustrates a conventional AWD driving method.

FIG. 5 illustrates a conventional AWD driving waveform.

FIG. 6 is electrode arrangement diagram of a PDP according to an exemplary embodiment of the present invention.

FIG. 7 and FIG. 8 illustrate a PDP according to an exemplary embodiment of the present invention.

FIG. 9 illustrates an AWD driving method of a PDP according to an exemplary embodiment of the present invention.

FIG. 10 illustrates wall charge distribution according to the waveform shown in FIG. 9.

FIGS. 11A and 11B illustrate results obtained by a simulation of a driving waveform according to an exemplary embodiment of the present invention.

FIG. 12 shows a plasma display device according to an exemplary embodiment of the present invention.

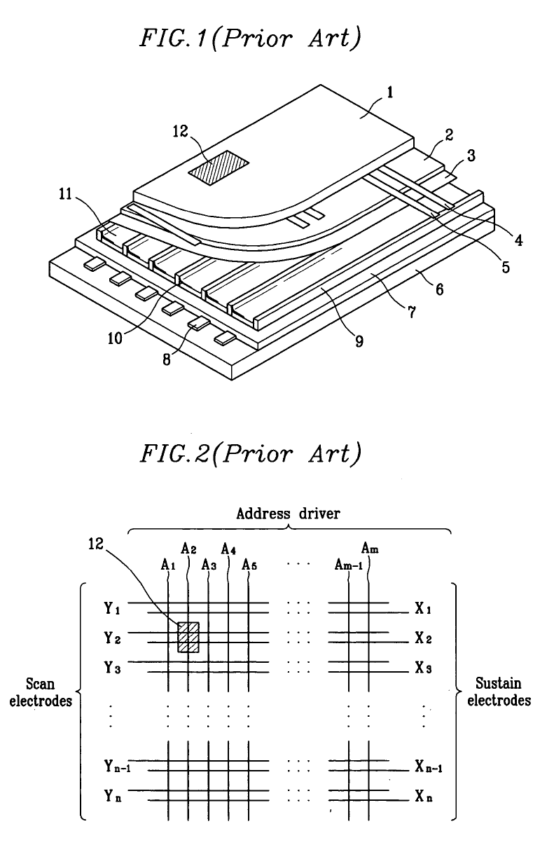

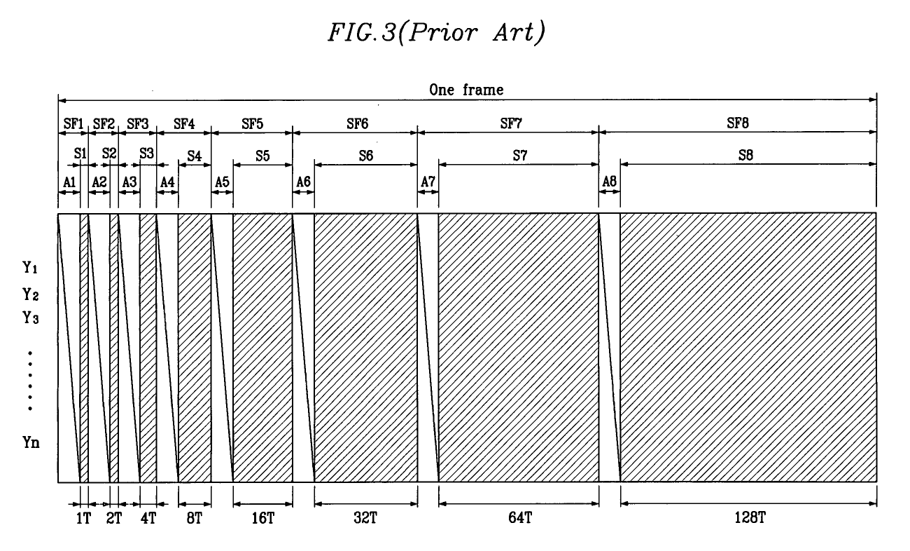

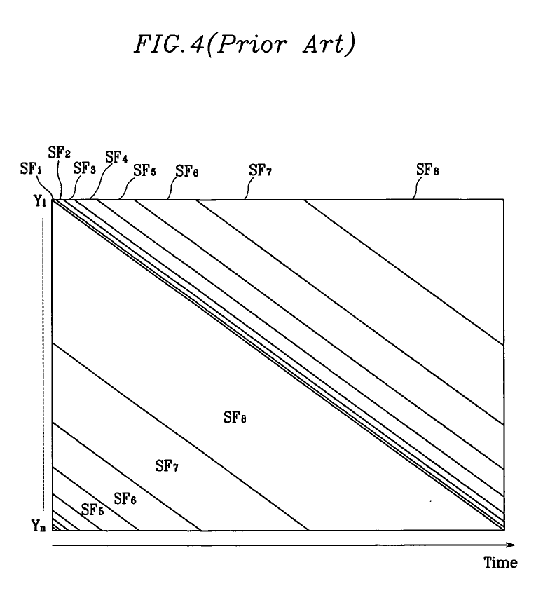

### DETAILED DESCRIPTION

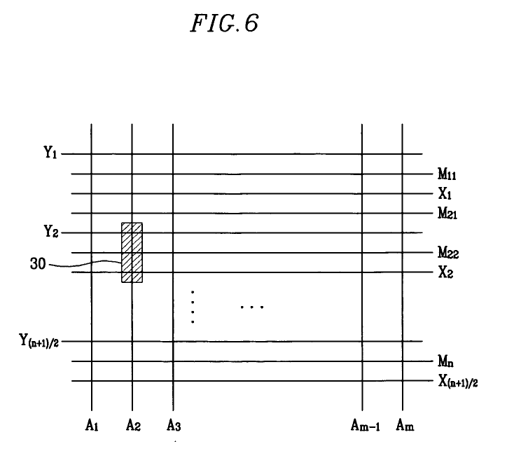

FIG. 6 is electrode arrangement diagram of a PDP according to an exemplary embodiment of the present invention. In the plasma display device a plurality of address electrodes A₁-Aₘ are arranged in parallel in a column direction. A plurality of Y electrodes Y₁-Y_{(n+1)/2}, a plurality of X₁-X_{(n+1)/2}, and a plurality of middle electrodes (M electrodes) M₁-Mₙ are arranged in a row direction. That is, according to the embodiment of the present invention, respective M electrodes are arranged between Y and X electrodes, and the PDP has a four electrode structure wherein four electrodes of Y, X, M, and address electrodes (e.g., Y₂, X₂, M₂₂, A₂) contribute to forming of a discharge cell 30.

According to an exemplary embodiment of the present invention, the X and Y electrodes are electrodes for receiving a sustain pulse, and the M electrode is an electrode for receiving a reset waveform and a scan pulse.

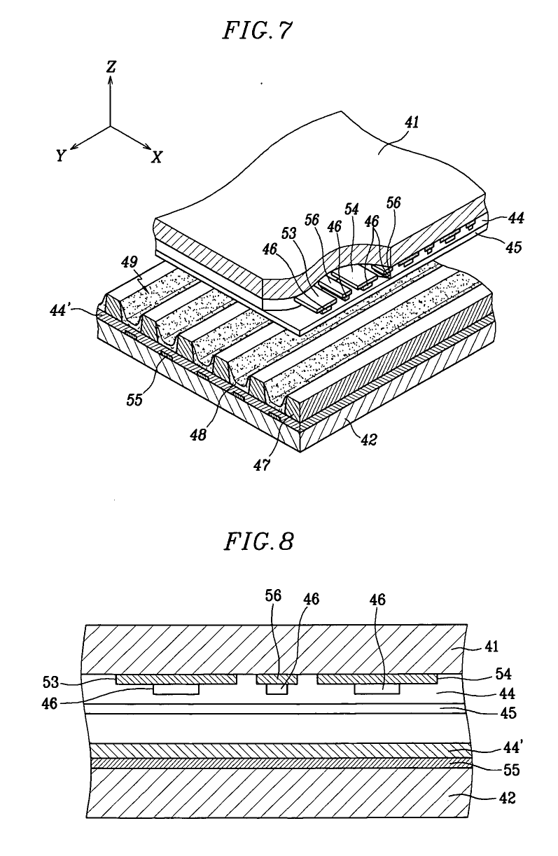

Referring now to FIG. 7 and FIG. 8, a PDP according to an exemplary embodiment of the present invention includes a first substrate 41 and a second substrate 42. An X electrode 53 and a Y electrode 54 are formed on the first substrate 41. In addition, bus electrodes 46 are formed on the X and Y electrodes 53, 54. In addition, a dielectric layer 44 and a protective layer 45 are consecutively formed on the X and Y electrodes 53, 54.

Address electrodes 55 are formed on the surface of the second substrate 42, and a dielectric layer 44′ is formed over the address electrodes 55 and the second substrate 42. Barrier ribs 47 are formed on the dielectric layer 44′ to thereby form cells 49 which are discharge spaces between the barrier ribs 47. Phosphor 48 is coated on the surface of the barrier rib 47 in the cell space between the barrier ribs 47. The X and Y electrodes 53, 54 are formed substantially perpendicular to the address electrode 55.

According to an exemplary embodiment of the present invention, an M electrode 56 is formed between a pair of the X and Y electrodes 53, 54 formed on the surface of the first substrate 41. As described above, a reset waveform and a scan pulse are applied to the M electrode. A bus electrode 46 is also formed on the M electrode 56.

M electrodes may be provided between the Xᵢ and Yᵢ electrodes and between the Yᵢ and Xᵢ₊₁ electrodes in the PDP according to exemplary embodiments of the present invention. That is, M electrodes are provided by a number n when X and Y electrodes are respectively provided by a number (n+1)/2. However, it is notable that the M electrodes 56 may be provided only between the Xᵢ and Yᵢ electrodes 53, 54 but not between the Yᵢ and Xᵢ₊₁, electrodes.

In addition, the M electrodes 56 may be provided only between the Yᵢ and Xᵢ₊₁ electrodes but not between the Xᵢ and Yᵢ electrodes. In such cases, the number of the X, Y, and M electrodes is each n.

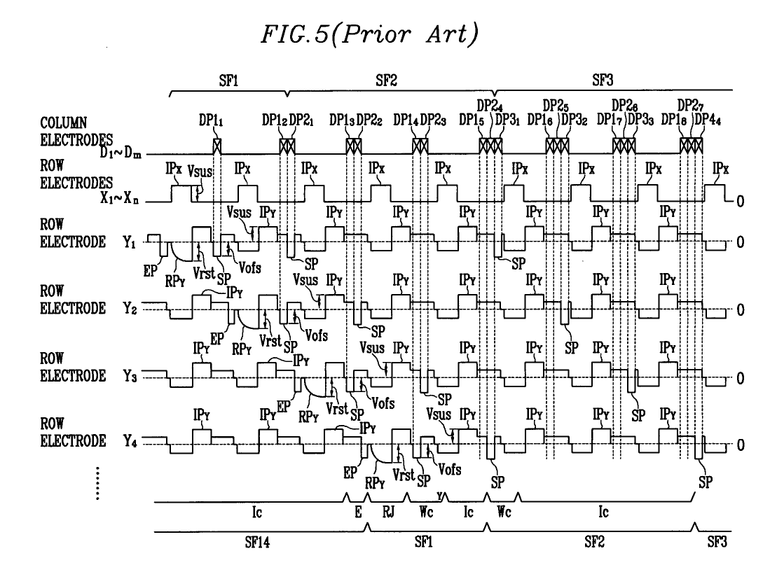

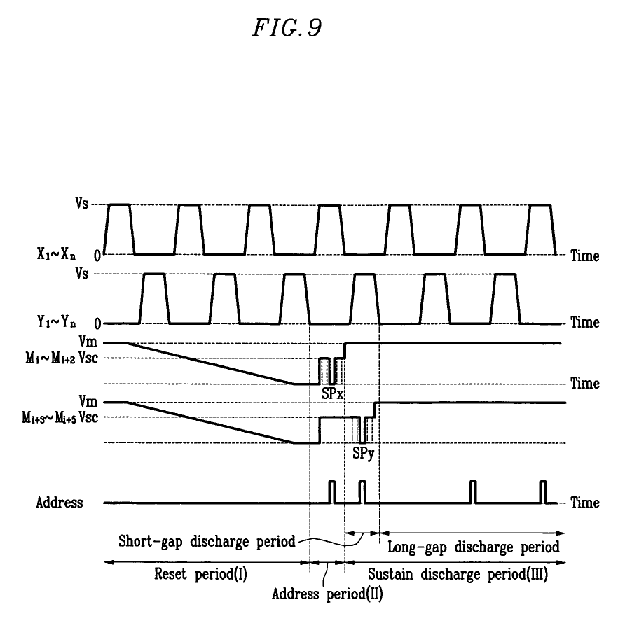

Each period shown in FIG. 9 is based on Mᵢ electrode among the M electrodes. In addition, the scan pulse SPx is sequentially applied to Mᵢ, Mᵢ₊₁, and Mᵢ₊₂ electrodes, and the scan pulse SPy is sequentially applied to Mᵢ₊₃, Mᵢ₊₄, and Mᵢ₊₅ electrodes. In FIG. 5, the reset waveform has been illustrated to be simultaneously applied to six M electrodes (i.e., Mᵢ-Mᵢ₊₅ electrodes), however, it is notable that more number of M electrodes may be simultaneously applied with the reset waveform.

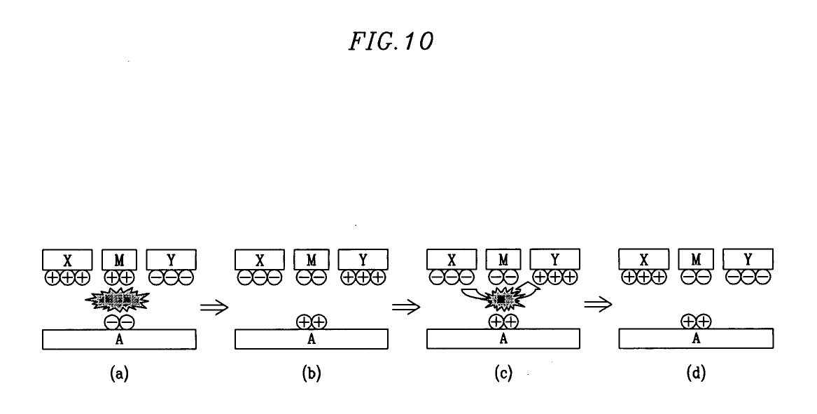

An AWD driving method according to an exemplary embodiment of the present invention is now described in detail with reference to FIG. 9 and FIG. 10. As shown in FIG. 9, according to a driving method of an exemplary embodiment of the present invention, a sustain pulse is applied to X and Y electrodes throughout a whole period, and the M electrode receives a reset waveform and a scan pulse. As such, according to an exemplary embodiment of the present invention, only the sustain pulse is applied to the Y electrode, and the scan pulse or the reset waveform is not necessarily applied thereto. Therefore, a circuit of the Y electrode may be simplified in comparison with a conventional AWD driving method. In addition, according to an exemplary embodiment of the present invention, a same sustain pulse is applied to the X and Y electrodes. Therefore, circuit impedance may be easily matched since the X and Y electrode driving circuits may be symmetrically designed.

According to an AWD driving method of an exemplary embodiment of the present invention, the X electrode, the Y electrode, the M electrode, and the address electrode forming a discharge cell are driven by a reset period, an address period, and a sustain period.

(1) Reset Period (I)

In this period, wall charges formed by a sustain pulse previously applied to the X and Y electrodes are eliminated, and the state of a cell is stabilized.

According to an exemplary embodiment of the present invention shown in FIG. 9, an electric potential of the M electrode decreases in a ramp waveform such that wall charges formed on the X and Y electrodes by a sustain pulse may be quenched. In this case, according to an exemplary embodiment of the present invention, a reset waveform is simultaneously applied to a predetermined number (six in FIG. 9) of M electrodes. As described above, it is notable that more number of M electrodes may be simultaneously applied with the reset waveform, although FIG. 9 illustrates the reset waveform to be simultaneously applied to six M electrodes (i.e., Mᵢ-Mᵢ₊₅ electrodes).

That is, according to an exemplary embodiment of the present invention, a waveform (refer to a ramp waveform shown in FIG. 9) gently decreasing from a voltage Vm to a ground voltage is applied to the M electrode. Wall charges of the X and Y electrodes are stably quenched by applying such a waveform to the M electrode while the sustain pulse is applied to the X and Y electrode. As such, according to an exemplary embodiment of the present invention, a waveform may overlap several sustain pulses since the reset waveform is applied to the M electrode differently from a conventional AWD driving scheme wherein a reset waveform is applied to a Y electrode.

Conventionally, a reset waveform should be within one sustain pulse because both of the sustain pulse and the reset waveform should be applied to the Y electrode. Because the reset waveform is applied during such a very short period, a reset light is generated to be relatively bright thereby causing deterioration of contrast. However, according to an exemplary embodiment of the present invention shown in FIG. 9, a reset waveform gently decreasing over several sustain pulses may be used, and therefore, a reset light may be reduced so as to enhance contrast.

(2) Address Period (II)

In the address period, while biasing a plurality of M electrodes at a voltage Vsc, the M electrodes are sequentially applied with a scan voltage (e.g., a ground voltage), and at the same time, address electrodes of turn-on cells (i.e., cells to be discharged) are applied with an address voltage. Then a discharge is generated between the M electrode and the address electrode and expands to the X and Y electrodes.

Hereinafter, a period during which the sustain pulse is applied to the X electrode is called an “X driving pulse on period”, and a period during which the sustain pulse is applied to the Y electrode is called a “Y driving pulse on period”. According to an exemplary embodiment of the present invention, a scan pulse may be applied during the X driving pulse on period and the Y driving pulse on period, and accordingly, temporal width of a scan pulse may be increased relative to the prior art. In FIG. 9, a pulse applied to the M electrode during the X driving pulse on period is denoted by SPx, and a pulse applied to the M electrode during the Y driving pulse on period is denoted by SPy. As described above, according to an exemplary embodiment of the present invention, temporal width of a scan pulse may be increased relative to a conventional AWD driving method, and accordingly, an address operation may become more accurate.

On the other hand, according to an AWD driving method according to an exemplary embodiment of the present invention, although not explicitly shown in FIG. 9, while an address discharge is performed between an M electrode and an address electrode regarding specific X and Y electrodes, a sustain discharge operation is performed with respect to other X and Y electrodes by applying a sustain pulse thereto.

(3) Sustain Discharge Period (III)

According to a sustain discharge period of an exemplary embodiment of the present invention, sustain discharge voltage pulses are alternately applied to the X and Y electrodes while biasing the M electrode to the sustain discharge voltage Vm. In a discharge cell selected in the address period, a sustain discharge is generated by the application of such a voltage.

According to an exemplary embodiment of the present invention, a discharge is generated by a different discharge mechanism depending on whether it is in an early state of a sustain discharge or a maximal state thereof. Hereinafter, for convenience of description, the discharge generated in the early state of the sustain discharge is called a short-gap discharge, and the discharge generated at a maximal state thereof is called a long-gap discharge. In addition, a period of the short-gap discharge is called a short-gap discharge period, and a period of the long-gap discharge is called a long-gap discharge period.

(3-1) Short-Gap Discharge Period

At the starting of the sustain discharge, as shown in the (a) portion and the (b) portion of FIG. 10, the X electrode (or the Y electrode) is applied with a positive (+) voltage pulse, and the Y electrode (or the X electrode) is applied with a negative (−) voltage pulse. At the same time, the M electrode is applied with a positive (+) voltage pulse. Here, the symbols of positive (+) and negative (−) are used in a relative meaning relating to comparison of voltage values applied to the X and Y electrodes. For example, the expression that the X electrode is applied with a positive (+) voltage pulse means that the X electrode is applied with a higher voltage than is the Y electrode. Therefore, in comparison with a conventional scheme by which the discharge occurs only between the X electrode and the Y electrode, the discharge occurs between the X electrode/M electrode and the Y electrode. In particular, according to an exemplary embodiment of the present invention, an electric field is formed higher between the M and Y electrodes than between the X and Y electrodes because a distance between the M and Y electrodes is shorter than a distance between the X and Y electrodes. Therefore, the discharge between the M and Y electrodes becomes more dominant than the discharge between the X and Y electrodes. According to an exemplary embodiment of the present invention, such a discharge is called a short-gap discharge in the sense that the discharge between the M and Y electrodes that are apart by a relatively short gap becomes dominant at the early state of the sustain discharge.

As described above, according to an exemplary embodiment of the present invention, a short-gap discharge is generated due to a high electric field at the early state of the sustain discharge. Therefore, when a first sustain pulse is applied after the address period, sufficient discharge may be achieved even if the discharge cell is not abundant in priming particles.

(3-2) Long-Gap Discharge Period

After the first sustain pulse of the sustain period, the M electrode is biased at a predetermined voltage VM and the discharge (i.e., short-gap discharge) between the M and X electrodes or between the M and Y electrodes negligibly contributes to a whole discharge. Therefore, in this case, the discharge between the X and Y electrodes becomes dominant, as shown in the (c) portion of FIG. 10, and consequently, an input image may be displayed corresponding to the number of discharge pulses alternately applied to the X and Y electrodes.

That is, as shown in the (d) portion of FIG. 10, in a normal state of the sustain period, the M electrodes remains accumulated with negative (−) wall charges, and the X and Y electrodes are alternately accumulated with negative (−) wall charge and positive (+) wall charges.

As described above, according to an exemplary embodiment of the present invention, a sufficient discharge is achieved in the early state of the sustain discharge even if priming particles are not abundant, because a discharge is generated by the short-gap discharge between the X and M electrodes (or between the Y and M electrodes). Furthermore, a stable discharge is achieved in the normal state because a discharge is generated by the long-gap discharge between the X and Y electrodes.

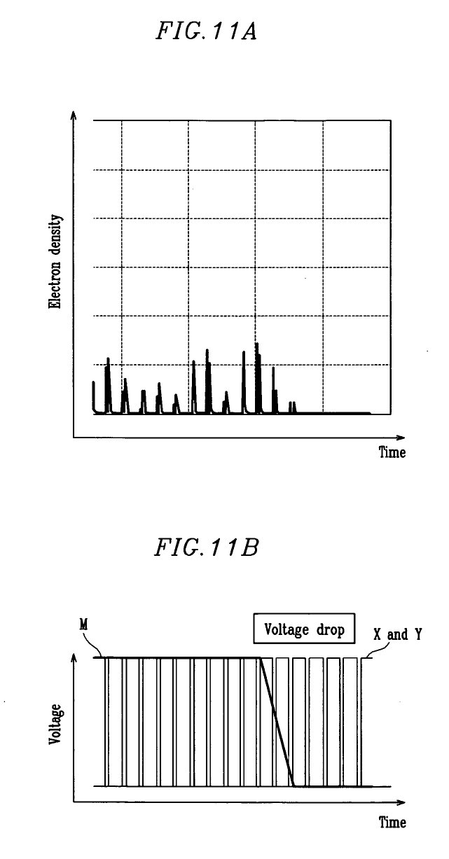

FIGS. 11(a) and 11(b) illustrate a result obtained by a simulation of discharge quenching caused by the reset waveform applied to the M electrode according to an exemplary embodiment of the present invention. FIG. 11(b) illustrates waveforms for the X, Y, and M electrodes. As shown in FIG. 11(b), the X and Y electrodes are alternately applied with a sustain pulse waveform, and the M electrode is applied with a ramp waveform that remains at a bias voltage Vm and then decreases to the ground voltage. FIG. 11 (a) illustrates an electron density. As shown in FIG. 11 (a), the electron density gradually decreases as the M electrode is applied with a ramp waveform, and it finally arrives at a 0 point. Here, the 0 point of the electron density implies that the discharge has stopped.

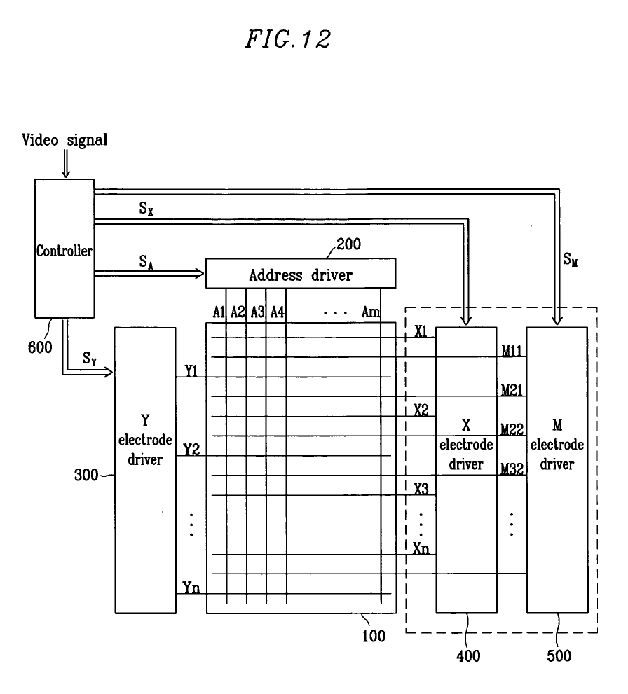

FIG. 12 shows a plasma display device according to an exemplary embodiment of the present invention. A plasma display device according to an exemplary embodiment of the present invention includes a PDP 100, an address driver 200, a Y electrode driver 300, an X electrode driver 400, an M electrode driver 500, and a controller 600.

The PDP 100 includes a plurality of address electrodes A₁ to Aₘ arranged in a column direction, and a plurality of Y electrodes Y₁ to Yₙ, X electrodes X₁ to Xₙ, and Mᵢⱼ electrodes arranged in a row direction. The Mᵢⱼ electrodes represent electrodes formed between the Yᵢ electrodes and the Xⱼ electrodes.

The address driver 200 receives an address driving control signal S_{A} from the controller 600, and applies a display data signal for selecting a discharge cell to be displayed to the respective address electrodes.

The Y electrode driver 300 receives a Y electrode driving signal S_{Y} from the controller 600, and applies to the Y electrodes the Y electrode waveform shown in FIG. 9.

The X electrode driver 400 receives an X electrode driving signal S_{X} from the controller 600, and applies to the X electrodes the X electrode waveform shown in FIG. 9.

The M electrode driver 500 receives an M electrode driving signal S_{M} from the controller 600, and applies to the M electrodes the M electrode waveform shown in FIG. 9.

The controller 600 receives external video signals, generates the address driving control signal S_{A}, the Y electrode driving signal S_{Y}, the X electrode driving signal S_{X}, and the M electrode driving signal S_{M}.

As described above, according to an exemplary embodiment of the present invention, a sustain pulse is alternately applied to the X and Y electrodes throughout a whole period, and the M electrode receives a reset waveform and a scan pulse. Therefore, contrast may be enhanced because a gently decreasing waveform is applicable.

In addition, according to an exemplary embodiment of the present invention, an almost symmetrical voltage waveform is applied to the X and Y electrodes, so driving circuits for driving the X and Y electrodes may be designed almost symmetrically. Therefore, since a circuit impedance difference between X and Y electrodes may be eliminated, distortion may be reduced in a pulse waveform applied to the X and Y electrodes in the sustain discharge period, and a stable discharge may be achieved.

As described above, according to an exemplary embodiment of the present invention, since a reset or an address discharge is performed using a middle electrode, an enhancement of contrast and prevention of faulty discharge may be achieved at the same time. Furthermore, according to an exemplary embodiment of the present invention, since a reset or an address discharge is performed using a middle electrode, a more accurate address operation and prevention of faulty discharge may be achieved at the same time.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A driving method of a plasma display device having at least one first electrode and at least one second electrode each applied with a sustain pulse, at least one third electrode formed in a same direction as the at least one first electrode and the at least one second electrode, and at least one fourth electrode crossing a respective first electrode, second electrode, and third electrode, the driving method comprising:
alternately applying the sustain pulse to the at least on first electrode and the at least on second electrode during a first period; and
applying a reset waveform to the at least one third electrode during a partial period of the first period.

2. The driving method of claim 1, wherein the reset waveform gradually decreases from a first voltage to a second voltage.

3. The driving method of claim 1, further comprising, after the applying of a reset waveform:
applying a scan pulse to the at least one third electrode; and
applying an address voltage to the at least one fourth electrode.

4. The driving method of claim 2, further comprising, after the applying of a reset waveform, applying a scan pulse to the at least one third electrode and an address voltage to the at least one fourth electrode.

5. The driving method of claim 1, further comprising, after the applying of a reset waveform:
applying a first scan pulse to an at least one third electrode corresponding to the at least one first electrode;
applying a second scan pulse to an at least one third electrode corresponding to the at least one second electrode; and
applying an address voltage to the at least one fourth electrode.

6. The driving method of claim 1, wherein the reset waveform is applied to the at least one third electrode while a plurality of sustain pulses are applied to the at least one first electrode or the at least one second electrode.

7. The driving method of claim 1, wherein:
the at least one first electrode, the at least one second electrode, the at least one third electrode, and the at least one fourth electrode are respectively provided as a plurality;
a discharge cell is formed by a corresponding first electrode, second electrode, third electrode, and fourth electrode; and
a sustain discharge is performed by applying the sustain pulse to a first electrode or a second electrode forming an m-th discharge cell while an address operation is performed by applying a scan pulse to a third electrode forming a j-th discharge cell.

8. The driving method of claim 7, wherein the reset waveform is simultaneously applied to a predetermined number of the third electrodes.

9. The driving method of claim 4, wherein the at least one third electrode is biased at a third voltage after the applying a scan pulse to the at least one third electrode and the address voltage to the at least one fourth electrode.

10. The driving method of claim 9, wherein the first voltage and the third voltage are of a same voltage level.

11. The driving method of claim 1, wherein a same waveform is applied to the at least one first electrode and the at least one second electrode throughout an entire period.

12. The driving method of claim 1, wherein the at least one third electrode is formed between the at least one first electrode and the at least one second electrode.

13. A driving method of a plasma display device having first electrodes and second electrodes applied with a sustain pulse, a third electrode formed in a same direction with the first electrodes and the second electrodes, and fourth electrodes crossing respective first electrodes, second electrodes, and third electrodes, the driving method comprising:
alternately applying the sustain pulse to the first electrodes and the second electrodes during a first period; and
applying a scan pulse to the third electrodes and an address voltage to the fourth electrodes during a partial period of the first period.

14. The driving method of claim 13 wherein:
at least one first electrode, at least one second electrode, at least one third electrode, and at least one fourth electrode are respectively provided as a plurality;
a discharge cell is formed by corresponding first electrodes, second electrodes, third electrodes, and fourth electrodes; and
a sustain discharge is performed by applying the sustain pulse to a first electrode or a second electrode forming an m-th discharge cell while an address operation is performed by applying a scan pulse to a third electrode forming a j-th discharge cell.

15. The driving method of claim 13, wherein a same waveform is applied to the first electrodes and the second electrodes throughout an entire period.

16. The driving method of claim 13, wherein third electrodes are formed between respective first electrodes and second electrodes.

17. A plasma display device comprising:
a plasma display panel having X electrodes and Y electrodes applied with a sustain discharge voltage pulse, M electrodes formed in a same direction with the X electrodes and Y electrodes, and address electrodes insulated from and crossing respective X electrodes, Y electrodes, and M electrodes;
an address driver for applying a display data signal for selecting a discharge cell to the address electrodes;
an X electrode driver and a Y electrode driver for respectively applying, during a first period, a sustain discharge voltage pulse for performing a sustain discharge to the X electrodes and the Y electrodes;
an M electrode driver for applying a scan pulse to the M electrodes while the sustain pulse is applied to the X electrodes and the Y electrodes; and
a controller for supplying a control signal to the address driver, the X electrode driver, the Y electrode driver, and the M electrode driver.

18. The plasma display device of claim 17, wherein the M electrode driver applies, before applying the scan pulse, a reset waveform decreasing from a first voltage to a second voltage to the M electrodes during a partial period of the first period.

19. The plasma display device of claim 17, wherein the M electrode driver applies a reset waveform to the M electrodes while a plurality of sustain pulses are applied to the X electrodes or the Y electrodes.

20. The plasma display device of claim 17, wherein an M electrode is formed between the respective first electrodes and second electrodes.
